(19) United States
(12) Patent Application Publication
(10) Pub. No.: US 2023/0111263 A1
(43) Pub. Date: Apr. 13, 2023

(54) PANORAMIC FMCW LIDAR AND VEHICLE

(71) Applicant: SHENZHEN ANTU AUTONOMOUS DRIVING TECHNOLOGIES LTD., SHENZHEN (CN)

(72) Inventor: JIANXIONG XIAO, SHENZHEN (CN)

(21) Appl. No.: 17/951,109

(22) Filed: Sep. 23, 2022

(30) Foreign Application Priority Data
Sep. 24, 2021 (CN) 202111124333.1

(51) Int. Cl. G01S 17/89; G01S 7/48; G01S 7/481; G01S 17/931; B60R 11/00

(52) U.S. Cl. CPC G01S 17/89; B60R 11/00; G01S 7/4802; G01S 7/4813; G01S 17/931; B60R 2011/004; B60R 2011/0085

(57) ABSTRACT

A panoramic FMCW lidar is provided. The panoramic FMCW lidarincludes a rotating member and a laser sensor. The rotating member is capable of being operatively rotated. The laser sensor, is arranged on the rotating member and rotated with the rotating member, the laser sensor includes one or more pairs of laser emitters and laser receivers, all laser emitters being arranged on the same side of the rotating member; each pair of the laser transmitters and the laser receivers are arranged adjacently, each laser transmitter is configured to transmit a frequency-modulated continuous wave optical signals, and each laser receiver is configured to receive reflected signals the reflected signals is configured to generate a panoramic point cloud related to an panoramic image of surrounding environment of the panoramic FMCW lidar, and the panoramic point cloud containing speed information.

### CROSS REFERENCE TO RELATED APPLICATION

This non-provisional patent application claims priority under 35 U.S.C. § 119 from Chinese Patent Application No.CN202111124333.1 filed on Sep. 24, 2021, the entire content of which is incorporated herein by reference.

### Technical Field

The disclosure relates to the technical field of lidar, in particular to a panoramic frequency modulation continuous wave laser(FMCW) lidar and a vehicle.

### BACKGROUND

The working principle of lidars is to transmit light signals to an target object, and receive the reflected signals reflected from the target object, and process the transmitted light signals and reflected signals to form a point cloud. As a result, the relevant information of the target object is obtained, such as distance, azimuth, height, speed and even shape and other parameters. However, different types of lidars form different point clouds and can obtain different target object information. For example, a TOF (Time of flight) lidar can form a wide field angle due to rotation, and the formed point cloud is of good quality and high density, but the speed information of the target object cannot be obtained from the point cloud. A FMCW (Frequency Modulated Continuous Wave) lidar cannot form a panoramic point cloud because of a small field angle, but the speed information of the target object can be obtained from the point cloud.

The Lidar is usually used in the driving field to assist vehicles in driving. During the driving of the vehicle, it is necessary to obtain the environmental information around the vehicle, and make predictions, decision-making and planning based on the environmental information and the speed information of the target object. However, the typical lidar cannot obtain the speed information of the target object while forming a panoramic point cloud.

Therefore, there is room for promotion in joystick sensor technology.

### SUMMARY

In a first aspect, a panoramic FMCW lidar is provided. The panoramic FMCW lidar includes a rotating member and a laser sensor. The rotating member is capable of being operatively rotated. The laser sensor, is arranged on the rotating member and rotated with the rotating member, the laser sensor includes one or more pairs of laser emitters and laser receivers, all laser emitters being arranged on the same side of the rotating member; each pair of the laser transmitters and the laser receivers are arranged adjacently, each laser transmitter is configured to transmit a frequency-modulated continuous wave optical signals, and each laser receiver is configured to receive reflected signals and the reflected signals are configured to generate a panoramic point cloud related to an panoramic image of surrounding environment of the panoramic FMCW lidar, and the panoramic point cloud containing speed information.

In a second aspect, a vehicle is provided, the vehicle includes a main body and a panoramic FMCW. The panoramic FMCW lidar includes a rotating member and a laser sensor. The rotating member is capable of being operatively rotated. The laser sensor, is arranged on the rotating member and rotated with the rotating member, the laser sensor includes one or more pairs of laser emitters and laser receivers, all laser emitters being arranged on the same side of the rotating member; each pair of the laser transmitters and the laser receivers are arranged adjacently, each laser transmitter is configured to transmit a frequency-modulated continuous wave optical signals, and each laser receiver is configured to receive reflected signals, the reflected signals is configured to generate a panoramic point cloud related to an panoramic image of surrounding environment of the panoramic FMCW lidar, and the panoramic point cloud containing speed information.

As described above, the laser sensor are arranged on the rotating member, the rotating member is configured to drive the laser sensor to rotate 360°, so that the panoramic FMCW lidar has a wider field angle. The laser sensor rotates by a lap that is 360°, and the point cloud about the surrounding environment of the panoramic FMCW lidar is formed, so that the panoramic FMCW lidar can form the panoramic point cloud faster and more efficiently. The rotating body rotates at a uniform speed, so that the point cloud in the panoramic point cloud is evenly distributed, so that the panoramic point cloud has a higher quality. At the same time, the laser transmitter emits frequency-modulated continuous waves, which can obtain the speed information of the target object, so that the panoramic point cloud includes the speed information, which has high practicability and application will more widely.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a schematic diagram of a FMCW lidar in accordance with an embodiment.

FIG. 2 illustrates a schematic diagram of an inner structure of the FMCW lidar in accordance with an embodiment.

FIG. 3 illustrates a schematic diagram of an arrangement of a plurality of pairs of laser transmitters and laser receivers of the panoramic FMCW lidar shown in FIG. 1.

FIG. 4 illustrates another schematic diagram of the arrangement of the plurality of pairs of laser transmitters and laser receivers of the panoramic FMCW lidar shown in FIG. 1.

FIG. 5 is illustrates a schematic diagram of a vehicle in accordance with an embodiment.

### DETAILED DESCRIPTION OF THE EMBODIMENTS

In order to make the purpose, technical solution and advantages of the disclosure more clearly, the disclosure is further described in detail in combination with the drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by the protection of the disclosure.

The terms “first”, “second”, “third”, “fourth”, if any, in the specification, claims and drawings of this application are used to distinguish similar objects but need not be used to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

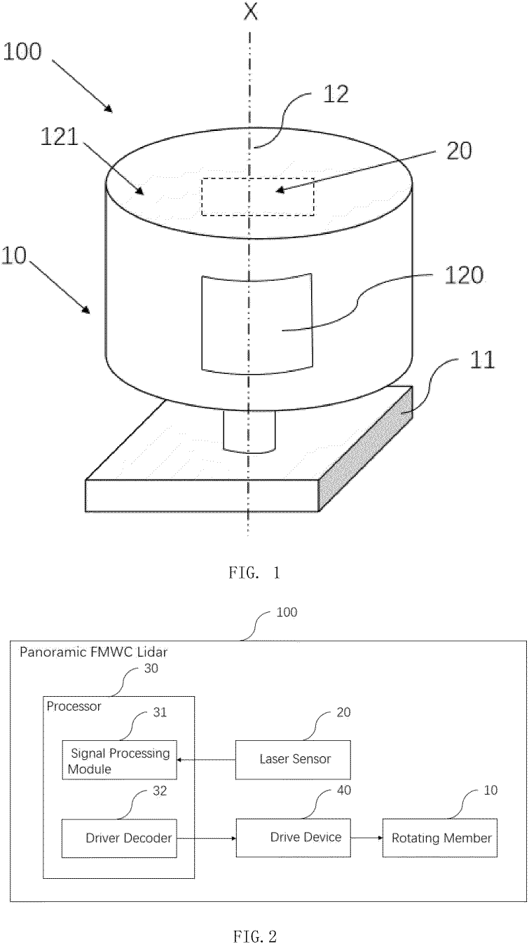

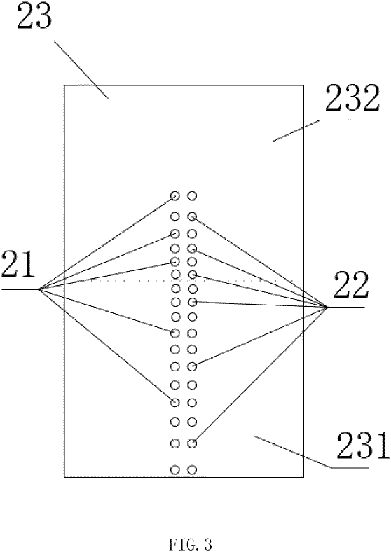

Referring to FIGS. 1 and 2, FIG. 1 illustrates a schematic diagram of a panoramic FMCW lidar in accordance with an embodiment, and FIG. 2 illustrates a schematic diagram of an inner structure of the panoramic FMCW lidar in accordance with an embodiment. The panoramic FMCW lidar 100 is configured to detect surrounding environment to form a panoramic point cloud about the surrounding environment, and at the same time can obtain the speed information of the target object. The panoramic FMCW lidar 100 can be installed in a vehicle to detect the surrounding environment of the vehicle, to assist the driving of the vehicle. The vehicles include but are not limited to cars, motorcycles, trucks, sport utility vehicles (SUV), recreational vehicles (RV), aircraft, etc. In some other embodiments, the panoramic FMCW lidar 100 can also be installed in other devices that needs to detect the surrounding environment, such as robots and airplanes.

The panoramic FMCW lidar 100 includes a rotating member 10 and a laser sensor 20. The rotating member 10 can be operatively rotated. The laser sensor 20 is mounted to the rotating member 10 and rotates with the rotating member 10. In this embodiment, the rotating member 10 can drive the laser sensor 20 to rotate 360°.

The rotating member 10 includes a base 11 and a rotating body 12, and the rotating body 12 is rotatably disposed on the base 11. The panoramic FMCW lidar 100 can be fixed to an external device through the base 11, and the external device includes, but is not limited to, a vehicle, a robot, an airplane, and the like. The rotating body 12 is substance in a cylindrical shaped, and the rotating body 12 rotates around the central axis of the rotating body 12. The rotating body 12 rotates at a uniform speed around a central axis X of the rotating body 12. It is understood that the rotating body 12 includes a circular end and is mounted on the base 11 via the circular end. The rotating body 12 can be set with different rotation speeds according to actual requirements. For example, when the surrounding environment to be detected is relatively simple and there are few target objects, the rotating body 12 can be set to rotate at a low rotation rate to form a sparse point cloud; when the surrounding environment to be detected is relatively complex and the target objects are relatively small, the rotating body 12 can be set to rotate at a higher rotation rate to form a dense point cloud.

The rotating body 12 defines a window 120. The window 120 is positioned on one side of the rotating body 12. In this embodiment, the window 120 is positioned on an outer surface of the rotating body 12. The rotating body 12 is substance in a cylindrical shaped that the rotating body 12 has a cylinder side surface. The window 120 may be an arc surface, which is adapted to the side surface of the rotating body 12; or the window 120 may also be a flat surface, which is parallel to a cut surface of the side surface of the rotating body 12. When the panoramic FMCW lidar 100 is installed in an external device and, the window 120 faces a movement direction of the external device when the panoramic FMCW lidar 100 is in an initial state. After the rotating body 12 rotates 360°, the window 120 still faces the moving direction of the external device.

The laser sensor 20 is mounted on the rotating body 12. The rotating body 12 defines a containing cavity 121, and the laser sensor 20 is fixed in the containing cavity 121. The laser sensor 20 includes at least one pair of a laser transmitter 21 and a laser receiver 22 arranged correspondingly, and each pair of the laser transmitter 21 and the laser receiver 22 are arranged adjacent to each other. In other words, the laser sensor 20 may include a pair of laser transmitters 21 and laser receivers 22, or may include a plurality of pairs of laser transmitters 21 and laser receivers 22. When the laser sensor 20 includes one pair of the laser transmitters 21 and the laser receivers 22, the panoramic FMCW lidar 100 can be used to detect a relatively simple surrounding environment; when the laser sensor 20 includes a plurality of pairs of laser transmitters 21 and laser receivers At 22:00, the panoramic FMCW lidar 100 can be configured to detect more complex surrounding environments. The laser emitters 21 is arranged on the same side of the rotating member 10. In this embodiment, the laser sensor 20 further includes a mounting plate 23, and the mounting plate 23 faces to the window 120. The mounting plate 23 is parallel to the cut surface of the window 120 or parallel to the window 120. The at least one pair of laser transmitters 21 and laser receivers 22 are arranged on the mounting board 23, and the laser transmitters 21 and the laser receivers 22 face the window 120 for emitting the optical signals or receiving the reflected signals from the window 120. The end of the laser transmitters 21 and end of the laser receivers 22 are located on a plane parallel to the mounting board 23 that the emitted optical signals and and reflected signals are emitted out of the laser sensor 20 from the same plane or the reflected signals enter into the the laser sensor 20 via the same plane.

When the laser sensor 20 includes the plurality of pairs of laser transmitters 21 and laser receivers 22, the plurality of pairs of the laser transmitters 21 and laser receivers 22 are arranged linearly or in an array, and the plurality of pairs of laser transmitters 21 and laser receivers 22 are arranged in the direction of the central axis X of the rotating body 12. The laser transmitters 21 in all the pairs of the laser transmitters 21 and the laser receivers 22 are located on the same side of the laser receiver 22. The laser transmitters 21 are all located in the right side or are all located in the left side of the corresponding laser receiver 22. In some embodiments, the relative positions of the laser transmitter 21 and the laser receiver 22 in each pair of the laser transmitter 21 and the laser receiver 22 are not limited. As shown in FIG. 3, the plurality of pairs of laser transmitters 21 and laser receivers 22 are linearly arranged on the mounting board 23. As shown in FIG. 4, the plurality of pairs of laser transmitters 21 and laser receivers 22 are arranged on the mounting board 23 in an array. In this embodiment, the number of the laser transmitters 21 and the laser receivers 22 arranged on one end of the rotating member 12 closed to the base 11 is larger than that of the laser transmitters 21 and laser receivers 22 arranged on the other end away from the base 11. In detail, the mounting plate 23 includes a first part 231 close to the base 11 and a second part 232 far away from the base 11. The first part 231 and the second part 232 divide the mounting plate 23 into two parts equally. The number of laser transmitters 21 and laser receivers 22 in the first part 231 is more than the number of laser transmitters 21 and laser receivers 22 in the second part 232. And the interval between the laser emitters 21 close to the edge of the mounting board 23 is greater than the interval between the laser emitters 21 arranged at the center of the mounting board 23. In other words, the interval between the laser emitters 21 gradually increases from the center of the mounting plate 23 to the edge of the mounting plate 23. It is understandable that the distribution of the laser transmitters 21 at the middle position of the mounting plate 33 is denser than the distribution at the edge position of the mounting plate 33, so that the data sensed within the field angle corresponding to the laser transmitter 21 at the middle position of the mounting plate 33 can be sensed is more accuracy. In other words, the laser transmitter 21 can adjust the density of the laser transmitter 21 on the mounting board 33 according to the actual sensing field angle.

Each laser transmitter 21 is configured to transmit frequency-modulated continuous wave optical signals, and each laser receiver 22 is configured to receive reflected signals of the optical signals reflected by the target object, the optical signals emitted by the laser transmitter 21 are emitted to the outside of the rotating body 12 through the window 120, and the reflected signals enter into the rotating body 12 through the window 120 and are received by the laser receiver 22. It can be understood that the laser sensors 20 is a frequency modulated continuous wave (FMCW) laser sensor 20. In this embodiment, each laser transmitter 21 emits a line of laser light. The number of laser transmitters 21 and laser receivers 22 can be set according to actual needs. For example, when the laser sensor 20 includes four pairs of laser transmitters 21 and laser receivers 22, the laser sensor 20 is a 4-line laser sensor; when the laser sensor 20 include one hundred and twenty-eight pairs of laser transmitters 21 and laser receivers 22 are included, the laser sensor 20 is a 128-line laser sensor. When the laser sensor 20 includes the plurality of laser emitters 21, the optical signals emitted by the laser emitters 21 in the laser sensor 20 have different frequencies. In other words, the frequencies of the optical signals emitted by all laser transmitters 21 are not the same, or all laser transmitters 21 are divided into several groups, and the frequency of the optical signals emitted by the laser transmitters 21 of the same group are the same, and the frequency of the optical signals emitted by the laser transmitters 21 of different groups are not the same.

The panoramic FMCW lidar 100 further includes a driving device 40 for driving the rotating member 10 to rotate. The driving device 40 drives the rotating body 12 to rotate.

The panoramic FMCW lidar 100 further includes a processor 30 positioned on the rotating body 12. The processor 30 includes a signals processing module 31, which generates a panoramic point cloud related to the panoramic image of the surrounding environment of the panoramic FMCW lidar 100 based on the transmitted light signals and the received reflected signals. It is understandable that when the rotating body 12 rotates for one lap, that is, after 360°, the signals processing module 31 forms a panoramic point cloud according to the optical signals and the reflected signals obtained by rotating one lap. When the laser sensor 20 includes a plurality of pairs of laser transmitters 21 and laser receivers 22, the signals processing module 31 forms a sub-point cloud according to the optical signals and reflected signals of each pair of laser transmitters 21 and laser receivers 22 respectively, and then joins the sub-point clouds into a panoramic point cloud. In some embodiments, the signals processing module 31 can directly process the optical signals and reflected signals of all laser transmitters 21 and laser receivers 22 to form a panoramic point cloud. Since the laser transmitter 21 emits a frequency-modulated continuous wave optical signals, the signals processing module 31 can obtain the speed of the target object based on the optical signals and the reflected signals. Correspondingly, the panoramic point cloud includes speed information of the target object. The signals processing module 31 is also configured to send the panoramic point cloud to an external device. The signals processing module 31 sends the panoramic point cloud to the external device through wireless transmission.

The processor 30 also includes a driver decoder 32. Among them, the drive decoder 32 is configured to generate relevant parameters for controlling the operation of the drive device 40.

In the above embodiment, the laser sensor are arranged on the rotating member, the rotating member is configured to drive the laser sensor to rotate 360°, so that the panoramic FMCW lidar has a wider field angle. The laser sensor rotates by a lap that is 360°, and the point cloud about the surrounding environment of the panoramic FMCW lidar is formed, so that the panoramic FMCW lidar can form the panoramic point cloud faster and more efficiently. The rotating body rotates at a uniform speed, so that the point cloud in the panoramic point cloud is evenly distributed, so that the panoramic point cloud has a higher quality. At the same time, the laser transmitter emits frequency-modulated continuous waves, which can obtain the speed information of the target object, so that the panoramic point cloud includes the speed information, which has high practicability and application will more widely..

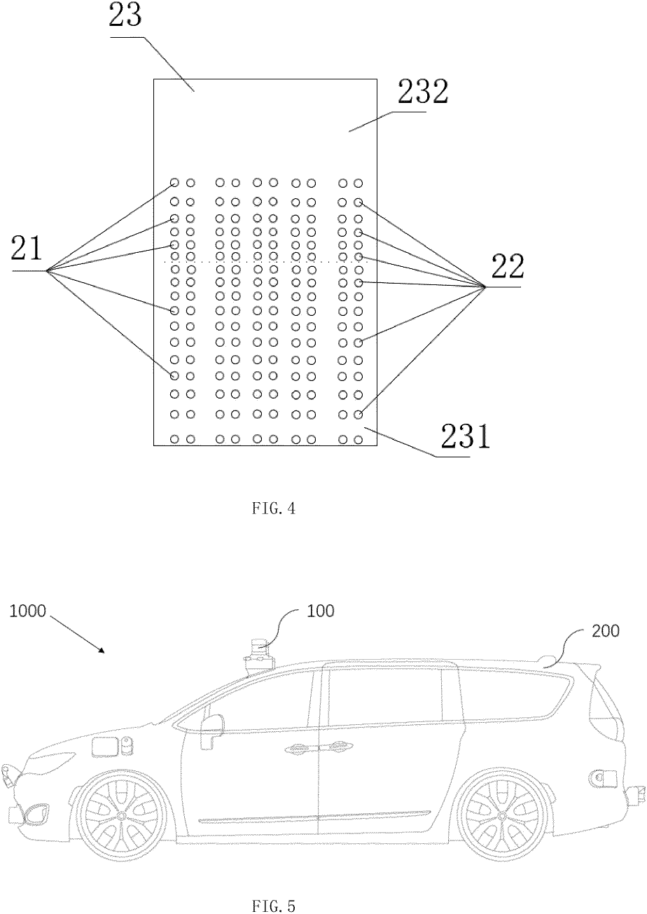

Referring to FIG. 5, a schematic diagram of a vehicle is illustrated in accordance with an embodiment. The vehicle 1000 includes a main body 200, and a panoramic FMCW lidar 100, and the panoramic FMCW lidar 100 is mounted on the main body 200. In this embodiment, the vehicle 1000 includes a panoramic FMCW lidar 100. For the specific structure of the panoramic FMCW lidar 100, refer to the above-mentioned embodiment. The panoramic FMCW lidar 100 is arranged on the top of the main body 200. The panoramic FMCW lidar 100 is fixed to the main body 200 through the base 11 of the rotating member 10. The vehicle 1000 includes the panoramic FMCW lidar 100 as described in above embodiments that the vehicle 1000 also has the technological advance of the panoramic FMCW lidar 100 as described above..

In some embodiments, the panoramic FMCW lidar 100 may be directly formed on the main body 200 through the rotating body 12 and integrated with the main body 200. In other words, the panoramic FMCW lidar 100 can be directly installed on the vehicle 1000 without the base 11.

The vehicle 1000 includes, but is not limited to, cars, motorcycles, trucks, sport utility vehicles (SUV), recreational vehicles (RV), aircraft, etc. The vehicle 1000 may be a non-autonomous driving vehicle or an autonomous driving vehicle. When the panoramic FMCW lidar 100 is installed in a non-autonomous vehicle, the panoramic point cloud formed by the panoramic FMCW lidar 100 can be used to assist the human driver to better understand the environment around the vehicle 1000. When the panoramic FMCW lidar 100 is installed in an autonomous vehicle, the panoramic point cloud formed by the panoramic FMCW lidar 100 can be configured to help the vehicle 1000 predict surrounding target objects, make decisions, and plan movement trajectory. The autonomous vehicle has a so-called level-four or level-five automation system. The level-four automation system refers to “highly automated”. In principle, a vehicle with a level-four automation system no longer needs human drivers to participate that even the human driver does not respond appropriately to an intervention request, the vehicle also can be capable of automatically adjusting to reach a low risk state. The level-five automation system refers to “ull automation”. The vehicle with the level-five automation system can realize automatic driving under any legal and drivable road environment. The human driver only needs to set the destination and start the system, and the vehicle will be drive to the designated location according to the most optimized route.

In the above embodiment, the panoramic point cloud formed by the panoramic FMCW lidar contains the speed information of the target object, the vehicle only needs to install a panoramic FMCW lidar that environmental information around the vehicle by 360 degree can be obtained and it greatly saves costs. The panoramic FMCW lidar is located on the top of the vehicle body, the speed information of the target object around the vehicle can be obtained, which can assist the vehicle to predict movements of the target object, and make decisions and plan a more suitable driving trajectory based on the prediction results.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a ...” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A panoramic FMCW lidar, comprising:
a rotating member, capable of being operatively rotated; and
a laser sensor, arranged on the rotating member and rotated with the rotating member, the laser sensor comprising one or more pairs of laser emitters, and laser receivers, each pair of the laser emitter and the laser receiver containing one laser emitter and one laser receiver arranged correspondingly to other, all laser emitters being arranged on the same side of the rotating member; each pair of the laser transmitters and the laser receivers are arranged adjacently, each laser transmitter being configured to transmit a frequency-modulated continuous wave optical signals, and each laser receiver being configured to receive reflected signals that formed by the optical signals reflected by an target object, the reflected signals being configured to generate a panoramic point cloud related to an panoramic image of surrounding environment of the panoramic FMCW lidar, and the panoramic point cloud containing speed information.

2. The panoramic FMCW lidar of claim 1, wherein the laser sensor comprises a plurality of pair of laser transmitters and laser receivers arranged correspondingly, and the panoramic FMCW lidar further comprises a processor, the processor forms sub-point clouds corresponding to the reflected signals of each pair of the laser transmitters and the laser receivers, and combines the sub-point clouds into the panoramic point cloud.

3. The panoramic FMCW lidar of claim 2, wherein the laser transmitter contains a plurality of laser sensors that emitting the optical signals with different frequency from each other.

4. The panoramic FMCW lidar of claim 2, wherein the rotating component comprises:
a base, the panoramic FMCW lidar being fixed to an external device through the base; and
a rotating body rotatably arranged on the base, and the laser sensor being arranged on the rotating body.

5. The panoramic FMCW lidar of claim 4, wherein the rotating body is cylindrical, and the rotating body rotates around an central axis of the rotating body.

6. The panoramic FMCW lidar of claim 1, wherein the rotating component can drive the laser sensor to rotate 360°.

7. The panoramic FMCW lidar of claim 6, wherein the laser sensor comprises a plurality of pairs of laser transmitters and laser receivers arranged correspondingly, and the plurality of pairs of the laser transmitters and the laser receivers are arranged in a straight line or in an array.

8. The panoramic FMCW lidar of claim 7, wherein the plurality of pairs of the laser transmitters and the laser receivers are arranged along an central axis of the rotating body, and the number of the laser transmitters and the laser receivers arranged on one end of the rotating member closed to the base is larger than that of the laser transmitters and laser receivers arranged on the other end away from the base.

9. The panoramic FMCW lidar of claim 4, wherein the rotating body defines a window, and the laser sensor further comprises a mounting plate facing to the window, and the one or more pair of the laser transmitters and the laser receivers are arranged on the mounting board, and the laser transmitter and the laser receiver are facing the window for emitting the optical signals or receiving the reflected signals from the window.

10. The panoramic FMCW lidar of claim 4, wherein the processor is further configured to send the panoramic point cloud to the external device.

11. The panoramic FMCW lidar of claim 2, wherein the panoramic FMCW lidar further comprises a driving device, and the driving device is configured to drive the rotating component to rotate.

13. A vehicle, comprises:
a main body; and
a panoramic FMCW lidar fixed on the main body, the panoramic FMCW lidar comprising:
a rotating member, capable of being operatively rotated; and
a laser sensor, arranged on the rotating member and rotated with the rotating member, the laser sensor comprising one or more pairs of laser emitters and laser receivers, each pair of the laser emitter and the laser receiver containing one laser emitter and one laser receiver arranged correspondingly to each other, all laser emitters being arranged on the same side of the rotating member each pair of the laser transmitters and the laser receivers are arranged adjacently, each laser transmitter being configured to transmit a frequency-modulated continuous wave optical signals, and each laser receiver being configured to receive reflected signals that formed by the optical signals reflected by an target object, the reflected signals being configured to generate a panoramic point cloud related to an panoramic image of surrounding environment of the panoramic FMCW lidar, and the panoramic point cloud containing speed information.

14. The vehicle of claim 13, wherein the laser sensor comprises a plurality of pair of laser transmitters and laser receivers arranged correspondingly, and the panoramic FMCW lidar further comprises a processor, the processor forms sub-point clouds corresponding to the reflected signals of each pair of the laser transmitters and the laser receivers, and combines the sub-point clouds into the panoramic point cloud.

15. The vehicle of claim 14, wherein the laser transmitter contains a plurality of laser sensors that emitting the optical signals with different frequency from each other.

16. The vehicle of claim 14, wherein the rotating component comprises:
a base, the panoramic FMCW lidar being fixed to an external device through the base; and
a rotating body rotatably arranged on the base, and the laser sensor being arranged on the rotating body.

17. The vehicle of claim 16, wherein the rotating body is cylindrical, and the rotating body rotates around an central axis of the rotating body.

18. The vehicle of claim 13, wherein the rotating component can drive the laser sensor to rotate 360°.

18. The vehicle of claim 17, wherein the laser sensor comprises a plurality of pairs of laser transmitters and laser receivers arranged correspondingly, and the plurality of pairs of the laser transmitters and the laser receivers are arranged in a straight line or in an array.

19. The vehicle of claim 18, wherein the plurality of pairs of the laser transmitters and the laser receivers are arranged along an central axis of the rotating body, and the number of the laser transmitters and the laser receivers arranged on one end of the rotating member closed to the base is larger than that of the laser transmitters and laser receivers arranged on the other end away from the base.

20. The vehicle of claim 14, wherein the rotating body defines a window, and the laser sensor further comprises a mounting plate facing to the window, and the one or more pair of the laser transmitters and the laser receivers are arranged on the mounting board, and the laser transmitter and the laser receiver are facing the window for emitting the optical signals or receiving the reflected signals from the window.
